(19) United States
(12) Patent Application Publication
(10) Pub. No.: US 2006/0108969 A1
(43) Pub. Date: May 25, 2006

(54) Apparatus for controlling speed of fan motor of air-conditioner

(75) Inventors: Seung-Do Han, Incheon (KR); Hyoun-Jeong Shin, Incheon (KR)

Correspondence Address: GREENBLUM & BERNSTEIN, P.L.C., 1950 ROLAND CLARKE PLACE, RESTON, VA, 20191, US

(73) Assignee: LG Electronics Inc., Seoul (KR)

(21) Appl. No.: 11/074,791

(22) Filed: Mar. 9, 2005

(30) Foreign Application Priority Data
Nov. 23, 2004 (KR) 96468/2004

(51) Int. Cl. H02P 7/36

(52) U.S. Cl. 318/807

(57) ABSTRACT

An apparatus for controlling a speed of a fan motor of an air-conditioner includes a frequency and voltage phase converter for simultaneously varying a voltage phase and frequency of a commercial AC power according to a control signal and applying a voltage varied according to the varied frequency and voltage phase to a fan motor of the air-conditioner; a zero voltage detector for receiving the commercial AC power and detecting a zero voltage of a voltage wave of the commercial AC power; and a microcomputer electrically connected with the zero voltage detector and the frequency and voltage phase converter, generating the control signal providing a predetermined frequency switching pattern according to a frequency command based on a point when the zero voltage is generated, and outputting the control signal to the frequency and voltage phase converter.

### BACKGROUND OF THE INVENTION

1. Field of the Invention

The present invention relates to an air-conditioner and, more particularly, to an apparatus for controlling a speed of a fan motor of an air-conditioner.

2. Description of the Conventional Art

In general, a single-phase induction motor is used as a fan motor of an air-conditioner. In order to generate rotating torque, the single-phase induction motor supplies a magnetizing current generating a rotating field and an induced current generated from a rotor to windings connected with an external power terminal.

The single-phase induction motor has a limitation in enhancing efficiency due to a primary copper loss of a stator and a secondary copper loss of the rotor.

In order to resolve such limitation, recently, a HIM (Hybrid Induction Motor) as shown in FIGS. 1 and 2 is used as a fan motor of the air-conditioner.

FIG. 1 is a schematic sectional view of the HIM in accordance with a conventional art, and FIG. 2 is a schematic sectional top view taken along line B-B′ of the HIM of FIG. 1.

As shown in FIGS. 1 and 2, a bracket 104 of the conventional HIM 100 includes a stator 105 and an induction rotor 101 installed at an inner side of the stator 105. A plurality of slots 108 are protrusively formed at an inner side of the stator 105 and coils 103 for applying a current are wound at the slots 108.

Aluminum rotor bars 112 are vertically inserted into a plurality of air gaps formed in an up/down direction at an edge of the rotor 101, and the aluminum rotor bars 112 are connected by an end ring 102.

A rotating shaft 109 for transferring a rotational force of the rotor 101 to outside is installed in an air gap 110 formed at the center of the induction rotor 101. The rotating shaft 109 can be rotated by an oilless bearing 107 installed at the bracket 104.

A permanent magnet rotor 106 for rotating the rotor 101 with a strong magnetic flux while being rotated by rotating field generated from the stator 105 is installed between the stator 105 and the induction rotor 101.

When an AC voltage is applied to the conventional HIM, the permanent magnet rotor 106 is rotated by the current applied to the coil 103 of the stator 105, and the rotating permanent magnet rotor 106 generates a rotating field with strong magnetic flux, to rotate the induction rotator 101. At this time, the permanent magnet rotor 106 in a low inertia state is separated from a fan (not shown) and rotated owing to the rotating field of the stator 105, and as a torque generating magnetic flux is supplied to the induction rotor 101 owing to the rotating field of the permanent magnet rotor 10, the induction rotor 101 is rotated.

In other words, when the permanent magnet rotor 106 is rotated by the rotating field in an oval form generated from the stator of the distributed windings, the permanent magnet rotor 106 generates rotating field with strong magnetic flux to make the induction rotor 101 rotated, so that the HIM is operated with high efficiency and low noise.

Velocity characteristics of the conventional apparatus for controlling a speed of the fan motor of the air-conditioner and a general induction motor will now be described with reference to FIGS. 3 and 4.

FIG. 3 is a circuit diagram showing the construction of the apparatus for controlling a speed of the fan motor (HIM) in accordance with the conventional art, and FIG. 4 is a graph showing speed characteristics of the conventional HIM and a general induction motor.

As shown in FIG. 3, when the apparatus for controlling a rotational speed of the fan motor by controlling a phase of a voltage applied to the fan motor (HIM) through one triac is applied for the HIM, a speed control range (i.e., 790˜880 RPM (revolution per minute, RPM) according to the voltage is limited as shown in FIG. 4. Namely, the speed control range is limited to the 790˜990 RPM due to the permanent magnet rotor 106. This causes a problem that the conventional apparatus for controlling the speed of the fan motor cannot be applied for air-conditioner which requires a speed control range or above 100 RPM.

U.S. Pat. No. 6,819,026 issued on Nov. 16, 2004 also discloses an induction motor used as a fan motor of an air-conditioner.

### SUMMARY OF THE INVENTION

Therefore, one object of the present invention is to provide an apparatus for controlling a speed of a fan motor of an air-conditioner capable of expanding a speed control range of a fan motor of an air-conditioner by simultaneously varying a phase and a frequency of an AC voltage according to a frequency command of a user.

Another object of the present invention is to provide an apparatus for controlling a speed of a fan motor of an air-conditioner capable of reducing power consumption of a fan motor of an air-conditioner by simultaneously varying a phase and a frequency of an AC voltage according a frequency command of a user.

To achieve these and other advantages and in accordance with the purpose of the present invention, as embodied and broadly described herein, there is provided an apparatus for controlling a speed of a fan motor of an air-conditioner including: a frequency and voltage phase converter for simultaneously varying a voltage phase and frequency of a commercial AC power according to a control signal and applying a voltage varied according to the varied frequency and voltage phase to a fan motor of the air-conditioner; a zero voltage detector for receiving the commercial AC power and detecting a zero voltage of a voltage wave of the commercial AC power; and a microcomputer electrically connected with the zero voltage detector and the frequency and voltage phase converter, generating the control signal providing a predetermined frequency switching pattern according to a frequency command based on a point when the zero voltage is generated, and outputting the control signal to the frequency and voltage phase converter.

To achieve the above object, there is also provided an apparatus for controlling a speed of a fan motor of an air-conditioner which includes an HIM (Hybrid Induction Motor) having a stator, an induction rotor and a permanent magnet rotor installed between the stator and the induction rotor, including: a frequency and voltage phase converter for simultaneously varying a voltage phase and frequency of a commercial AC power according to a control signal and applying a voltage varied according to the varied frequency and voltage phase to an HIM of the air-conditioner; a zero voltage detector for receiving the commercial AC power and detecting a zero voltage of a voltage wave of the commercial AC power; and a microcomputer electrically connected with the zero voltage detector and the frequency and voltage phase converter, generating the control signal providing a predetermined frequency switching pattern according to a frequency command based on a point when the zero voltage is generated, and outputting the control signal to the frequency and voltage phase converter, wherein the frequency and voltage phase converter includes a first triac; a second triac connected in series to the first triac; a third triac connected in parallel to the first triac; and a fourth triac connected in series to the third triac and connected in parallel to the second triac, and the HIM is electrically connected with a first junction between the first and second triacs and a second junction between the third and fourth triacs.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a schematic sectional view of the HIM in accordance with a conventional art;

FIG. 2 is a schematic sectional top view taken along line B-B′ of the HIM of FIG. 1;

FIG. 3 is a circuit diagram showing the construction of the apparatus for controlling a speed of the fan motor (HIM) in accordance with the conventional art;

FIG. 4 is a graph showing speed characteristics of the conventional HIM and a general induction motor;

FIG. 5 is a schematic view showing the construction of an apparatus for controlling a speed of a fan motor of an air-conditioner in accordance with a preferred embodiment of the present invention;

FIG. 6 is a block diagram showing the construction of a frequency and voltage phase converter of the apparatus for controlling a speed of a fan motor of an air-conditioner in accordance with the preferred embodiment of the present invention;

FIGS. 7A to 7F show waveforms showing six embodiments of frequency switching patterns in accordance with the present invention; and

FIG. 8 is a graph showing power consumption and the number of times of rotation of a HIM when the apparatus for controlling a speed of a fan motor of an air-conditioner is applied for the HIM compared with a conventional art in accordance with the present invention.

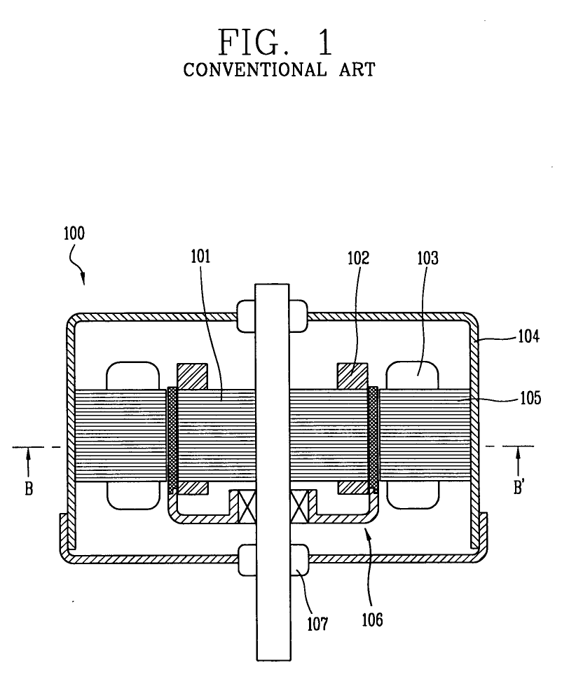

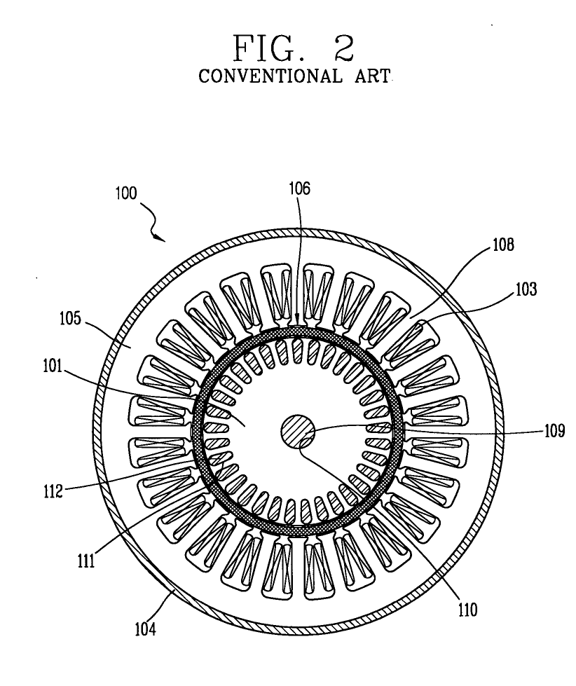

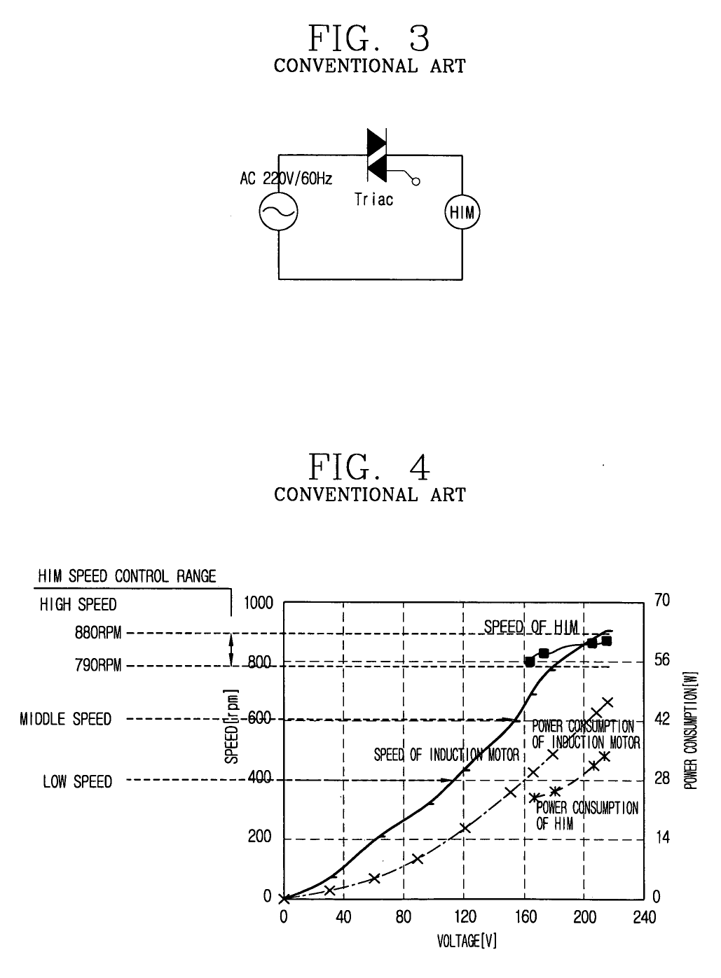

### DETAILED DESCRIPTION OF THE PREFERRED EMBODIMENTS

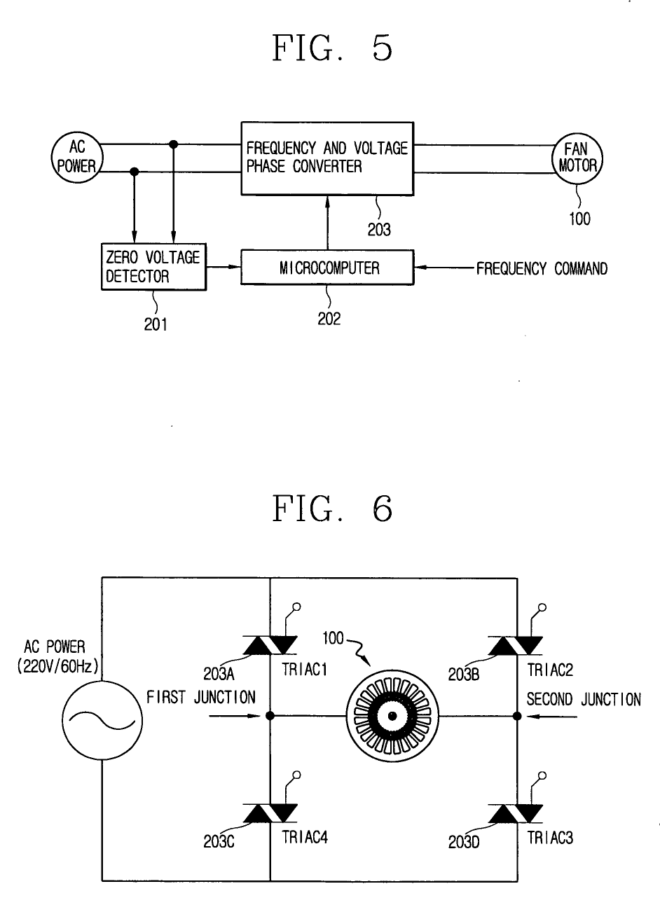

An apparatus for controlling a speed of a fan motor of an air-conditioner capable of expanding a speed control range of a fan motor of an air-conditioner and reducing power consumption of the fan motor by simultaneously varying a phase and a frequency of an AC voltage according to a frequency command of a user, in accordance a preferred embodiment of the present invention will now be described with reference to FIGS. 5 to 8.

FIG. 5 is a schematic view showing the construction of an apparatus for controlling a speed of a fan motor of an air-conditioner in accordance with a preferred embodiment of the present invention.

As shown in FIG. 5, the apparatus for controlling a speed of a fan motor of an air-conditioner includes: a frequency and voltage phase converter 203 for simultaneously varying a voltage phase and frequency of a commercial AC power according to a control signal and applying a voltage varied according to the varied frequency and voltage phase to a fan motor (HIM) 100 of the air-conditioner; a zero voltage detector 201 for receiving the commercial AC power and detecting a zero voltage of a voltage wave of the commercial AC power; and a microcomputer 202 electrically connected with the zero voltage detector 201 and the frequency and voltage phase converter 203, generating the control signal providing a predetermined frequency switching pattern according to a frequency command based on a point when the zero voltage is generated, and outputting the control signal to the frequency and voltage phase converter.

Herein, the fan motor of the air-conditioner is the HIM 100. The microcomputer 202 includes a memory (not shown). The memory previously stores frequency switching patterns for implementing a frequency for controlling a speed of the fan motor 100 according to a frequency command.

When a frequency of an output voltage waveform is lowered, the microcomputer 202 increases a firing angle of the output voltage waveform. For example, if the frequency of the output voltage waveform is increased, the microcomputer 202 reduces the firing angle of the output voltage waveform inverse-proportionally, and when the frequency of the output voltage waveform is reduced, the microcomputer 202 increases the firing angle of the output voltage waveform inverse-proportionally.

FIG. 6 is a block diagram showing the construction of a frequency and voltage phase converter of the apparatus for controlling a speed of a fan motor of an air-conditioner in accordance with the preferred embodiment of the present invention.

As shown in FIG. 6, the frequency and voltage phase converter 203 includes a first switching device 203A; a second switching device 203C connected in series with the first switching device 203A; a third switching device 203B connected in parallel with the first switching device 203A; and a fourth switching device 203D connected in series with the third switching device 203B and connected in parallel with the second switching device 203C.

The fan motor 100 is electrically connected with a first junction between the first and second switching devices 203A and 203C and with a second junction between the third and fourth switching devices 203B and 203D. Namely, the first and fourth switching devices 203A and 203D are installed in a forward direction with respect to the fan motor 100, and the second and third switching devices 203B and 203C are installed in a reverse direction with respect to the fan motor 100. As the first to fourth switching devices 203A˜203D, a triac or an inverter is preferably used, and in the present invention, the first to fourth switching devices 203A˜203D are formed as triacs (triac1˜triac4), respectively.

The operation of the apparatus for controlling a speed of the fan motor of the air-conditioner in accordance with the present invention will now be described with reference to FIGS. 5 and 6.

First, when a frequency command for controlling a speed of the fan motor 100 is generated by a user, the microcomputer 202 selects a predetermined frequency switching pattern corresponding to the frequency command from the memory and outputs a control signal for providing the selected frequency switching pattern based on a point at which a zero voltage is generated as detected by the zero voltage detector 10, to the frequency and voltage phase converter 203.

The frequency and voltage phase converter 203 controls the speed of the fan motor 100 by controlling ON/OFF of the four triacs triac1˜triac 4 according to the control signal. Herein, the frequency switching pattern can be determined variably according to the frequency command.

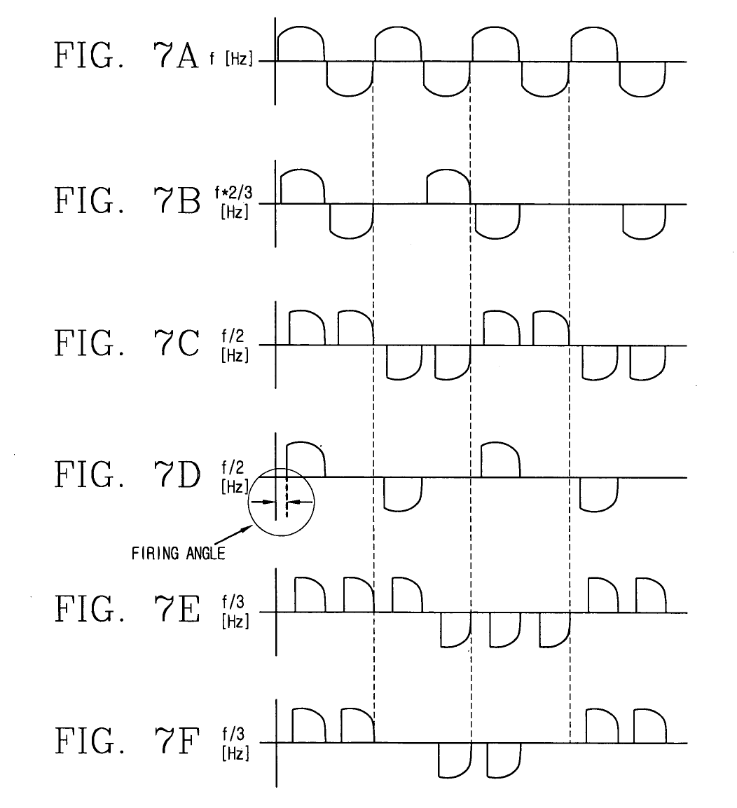

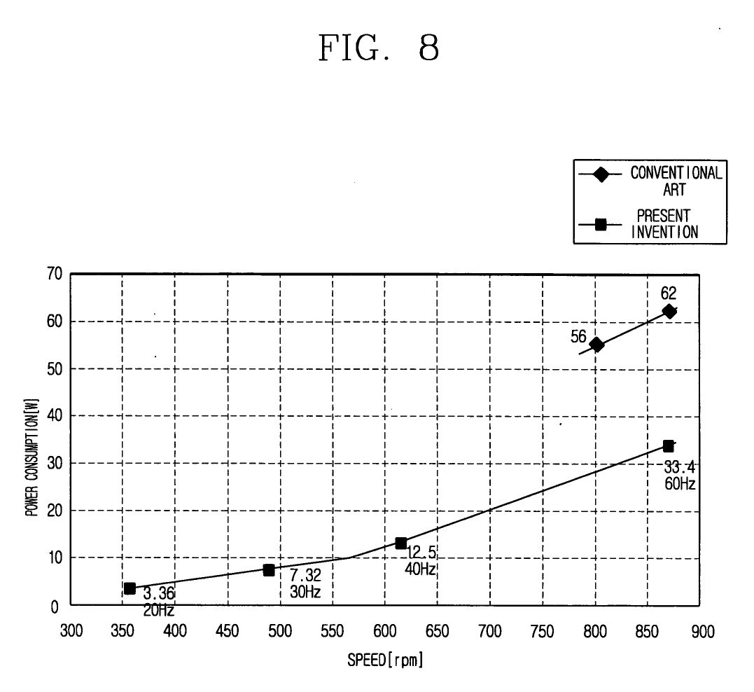

Six types of embodiments of the frequency switching patterns according to the frequency command will be described with reference to FIGS. 7A to 7F as follows.

FIGS. 7A to 7F show waveforms showing six embodiments of frequency switching patterns in accordance with the present invention.

As shown in FIG. 7A, as for a first frequency switching pattern, when a frequency command for maintaining a frequency (f) of a commercial AC voltage (e.g., 60 Hz) by a user is inputted, only the first and fourth switching devices triac1 and triac3 are turned according to a predetermined first firing angle (e.g., 10°) during an entire period of the commercial AC voltage waveform. Namely, when the firing angle of the commercial AC voltage waveform is 10°, the frequency waveform as shown in FIG. 7A can be generated by turning on only the first and the fourth switching devices.

Herein, with the commercial AC voltage set as 220V and the frequency (f) of the commercial AC voltage set as 60 Hz, when the frequency and voltage phase converter 203 of the speed controlling apparatus is operated according to the first frequency switching pattern, an experimentation reveals that a voltage applied to the HIM 100 was measured as 219V and a speed of the HIM was measured as 855 RPM.

As shown in FIG. 7B, as for the second frequency switching pattern, when a frequency command for converting the frequency (f) of the commercial AC voltage into a voltage of f*⅔ (e.g., 40 Hz) is inputted by the user, a first step of turning on the first and fourth switching devices Triac1 and Triac3 during one period, a second step of turning off the first and the fourth switching devices Triac1 and Triac3 during the next half (½) period, and a third step of inverting the voltage by turning on the second and third switching devices Triac2 and Triac4 during the next one period are performed, and then, the first to third steps are repeatedly performed according to a pre-set second firing angle (e.g., 20°) to generate a frequency waveform as shown in FIG. 7B. For example, when the firing angle of the commercial AC voltage waveform is 20°, the frequency waveform as shown in FIG. 7B can be generated by repeatedly performing the first to third steps.

Herein, with the commercial AC voltage set as 220V and the frequency (f) of the commercial AC voltage set as 60 Hz, when the frequency and voltage phase converter 203 of the speed controlling apparatus is operated according to the second frequency switching pattern, an experimentation reveals that a voltage applied to the HIM 100 was measured as 138V and a speed of the HIM was measured as 613 RPM.

As shown in FIG. 7C, as for the third frequency switching pattern, when a frequency command for converting the frequency (f) of the commercial AC voltage into a voltage of f/2 (e.g., 30 Hz) is inputted by the user, a first step of turning on the first and fourth switching devices Triac1 and Triac3 during one period and a second step of inverting the voltage by turning on the second and third switching devices Triac2 and Triac4 during the next one period are performed, and then, the first and second steps are repeatedly performed according to a pre-set third firing angle (e.g., 50°) to generate a frequency waveform as shown in FIG. 7C. For example, when the firing angle of the commercial AC voltage waveform is 50°, the frequency waveform as shown in FIG. 7C can be generated by repeatedly performing the first and second steps.

Herein, with the commercial AC voltage set as 220V and the frequency (f) of the commercial AC voltage set as 60 Hz, when the frequency and voltage phase converter 203 of the speed controlling apparatus is operated according to the third frequency switching pattern, an experimentation reveals that a voltage applied to the HIM 100 was measured as 119V and a speed of the HIM was measured as 492 RPM.

Meanwhile, when the voltage generated according to the third frequency switching pattern is applied to the fan motor 100, a phase of the voltage at the both ends of the triacs Triac1 and Triac4 can be delayed due to a back electromotive force, and thus an arm short and a driving error can be possibly generated. Thus, it is preferred to apply the voltage generated according to the fourth frequency switching pattern to the fan motor 100.

As shown in FIG. 7D, as for the fourth frequency switching pattern, when a frequency command for converting the frequency (f) of the commercial AC voltage into a voltage of f/2 (e.g., 30 Hz) is inputted by the user, a first step of turning on the first and fourth switching devices Triac1 and Triac3 during a half (½) period, a second step of turning off the first and the fourth switching devices Triac1 and Triac3 during the next half (½) period, a third step of inverting the voltage by turning on the second and third switching devices Triac2 and Triac4 during the next half (½) period, and a fourth step of turning off the second and third switching devices Triac2 and Triac4 during the next half (½) period are performed, and then, the first to fourth steps are repeatedly performed according to a pre-set fourth firing angle (e.g., 40°) to generate a frequency waveform as shown in FIG. 7D. For example, when the firing angle of the commercial AC voltage waveform is 40°, the frequency waveform as shown in FIG. 7D can be generated by repeatedly performing the first to fourth steps.

Namely, using of the fourth frequency switching pattern prevents generation of the arm short and driving error. In this respect, preferably, the predetermined fourth firing angle is set to be smaller than the predetermined third firing angle in order to prevent the arm short and the driving error. Herein, with the commercial AC voltage set as 220V and the frequency (f) of the commercial AC voltage set as 60 Hz, when the frequency and voltage phase converter 203 of the speed controlling apparatus is operated according to the fourth frequency switching pattern, an experimentation reveals that a voltage applied to the HIM 100 was measured as 111V and a speed of the HIM was measured as 497 RPM.

As shown in FIG. 7E, as for the fifth frequency switching pattern, when a frequency command for converting the frequency (f) of the commercial AC voltage into a voltage of f/3 (e.g., 20 Hz) is inputted by the user, a first step of turning on the first and fourth switching devices Triac1 and Triac3 during a half (½) period, a second step of inverting the voltage by turning on the second and third switching devices Triac2 and Triac4 during the next half (½) period, a third step of turning on the first and the fourth switching devices Triac1 and Triac3 during the next half (½) period, a fourth step of inverting the voltage by turning on the second and third switching devices Triac2 and Triac4 during the next half (½) period, and a fifth step of turning on the first and fourth switching devices Triac1 and Triac3 during the next half (½) period are performed, and then, the first to fifth steps are repeatedly performed according to a pre-set fifth firing angle (e.g., 70°) to generate a frequency waveform as shown in FIG. 7E. For example, when the firing angle of the commercial AC voltage waveform is 70°, the frequency waveform as shown in FIG. 7E can be generated by repeatedly performing the first to fifth steps.

Herein, with the commercial AC voltage set as 220V and the frequency (f) of the commercial AC voltage set as 60 Hz, when the frequency and voltage phase converter 203 of the speed controlling apparatus is operated according to the fifth frequency switching pattern, an experimentation reveals that a voltage applied to the HIM 100 was measured as 91V and a speed of the HIM was measured as 355 RPM.

Meanwhile, when the voltage generated according to the fifth frequency switching pattern is applied to the fan motor 100, a phase of the voltage at the both ends of the triacs Triac1 and Triac4 can be delayed due to a back electromotive force, and thus an arm short and a driving error can be possibly generated. Thus, it is preferred to apply the voltage generated according to the sixth frequency switching pattern to the fan motor 100.

As shown in FIG. 7F, as for the sixth frequency switching pattern, when a frequency command for converting the frequency (f) of the commercial AC voltage into a voltage of f/3 (e.g., 20 Hz) is inputted by the user, a first step of turning on the first and fourth switching devices Triac1 and Triac3 during a half (½) period, a second step of inverting the voltage by turning on the second and third switching devices Triac2 and Triac4 during the next half (½) period, a third step of turning off the second and third switching devices Triac2 and Triac4 during the next half (½) period, a fourth step of turning on the first and the fourth switching devices Triac1 and Triac3 during the next half (½) period, a fifth step of inverting the voltage by turning on the second and third switching devices Triac2 and Triac4 during the next half (½) period, and a sixth step of turning off the second and third switching devices Triac2 and Triac4 during the next half (½) period are performed, and then, the first to-sixth steps are repeatedly performed according to a pre-set sixth firing angle (e.g., 60°) greater than the predetermined fifth firing angle to generate a frequency waveform as shown in FIG. 7F. For example, when the firing angle of the commercial AC voltage waveform is 60°, the frequency waveform as shown in FIG. 7F can be generated by repeatedly performing the first to sixth steps.

Namely, using of the sixth frequency switching pattern prevents generation of the arm short and driving error. In this respect, preferably, the predetermined sixth firing angle is set to be smaller than the predetermined fifth firing angle in order to prevent the arm short and the driving error.

Herein, with the commercial AC voltage set as 220V and the frequency (f) of the commercial AC voltage set as 60 Hz, when the frequency and voltage phase converter 203 of the speed controlling apparatus is operated according to the sixth frequency switching pattern, an experimentation reveals that a voltage applied to the HIM 100 was measured as 84V and a speed of the HIM was measured as 357 RPM.

FIG. 8 is a graph showing power consumption and the number of times of rotation of a HIM when the apparatus for controlling a speed of a fan motor of an air-conditioner is applied for the HIM compared with a conventional art in accordance with the present invention.

As shown in FIG. 8, the apparatus for controlling the speed of the fan motor of the air-conditioner in accordance with the present invention can extend a speed control range of the fan motor of the air-conditioner and reduce power consumption by simultaneously varying the phase and the frequency of the commercial AC voltage according to a command of the user by using the four triacs.

For example, when the apparatus for controlling the speed of the fan motor of the air-conditioner is applied for the HIM 100, the speed control ranges of the fan motor of the air-conditioner are 355, 357, 492, 497, 613 and 855 RPM (the speed control range of the HIM in the present invention is 355˜855 RPM), so that the speed control range can be applied for an air-conditioner which requires a speed control range of above 100 RPM. In addition, by applying the apparatus for controlling the speed of the fan motor of the air-conditioner to the HIM, power consumption of the fan motor of the air-conditioner can be reduced.

As so far described, the apparatus for controlling the speed of the fan motor of the air-conditioner in accordance with the present invention has such an advantage that the speed control range of the HIM can be extended and power consumption of the HIM can be reduced by simultaneously varying the phase and the frequency of the commercial AC voltage according to a frequency command of a user by using the four triacs.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

1. An apparatus for controlling a speed of a fan motor of an air-conditioner which comprises an HIM (Hybrid Induction Motor) having a stator, an induction rotor and a permanent magnet rotor installed between the stator and the induction rotor, comprising:
a frequency and voltage phase converter that simultaneously varies a voltage phase and a frequency of a commercial AC power according to a control signal and applies a voltage varied according to the varied frequency and voltage phase to the HIM of the air-conditioner;
a zero voltage detector that receives the commercial AC power and detects a zero voltage of a voltage wave of the commercial AC power; and
a microcomputer electrically connected with the zero voltage detector and the frequency and voltage phase converter, generating the control signal providing a predetermined frequency switching pattern according to a frequency command based on a point when the zero voltage is generated, and outputting the control signal to the frequency and voltage phase converter.

2. The apparatus of claim 1, wherein the microcomputer comprises a memory that stores frequency switching patterns that have been predetermined according to the frequency command.

3. The apparatus of claim 1, wherein the microcomputer increases a firing angle of the output voltage when the frequency of the output voltage is lowered.

4. The apparatus of claim 1, wherein when the frequency of the output voltage is increased, the microcomputer reduces the firing angle of the output voltage waveform inverse-proportionally, and when the frequency of the output voltage waveform is reduced, the microcomputer increases the firing angle of the output voltage waveform inverse-proportionally.

5. The apparatus of claim 1, wherein the frequency and voltage phase converter comprises:
a first switching device:
a second switching device connected in series with the first switching device;
a third switching device connected in parallel with the first switching device; and
a fourth switching device connected in series with the third switching device and connected in parallel with the second switching device,
wherein the fan motor is electrically connected with a first junction between the first and second switching devices and with a second junction between the third and fourth switching devices.

6. The apparatus of claim 4, wherein the first to fourth switching devices are triacs, respectively.

7. The apparatus of claim 4, wherein the first to fourth switching devices are inverters, respectively.

8. The apparatus of claim 5, wherein when a frequency command that maintains the frequency of the commercial AC power is inputted by a user, the frequency switch pattern turns on only the first and fourth switching devices according to a pre-set firing angle during an entire period of a voltage waveform of the commercial AC.

9. The apparatus of claim 5,
wherein, as for the frequency switch pattern, when a frequency command to convert the frequency (f) of the commercial AC voltage into a voltage of f*⅔ is inputted by the user,
a first step of turning on the first and fourth switching devices during one period,
a second step of turning off the first and the fourth switching devices during the next half period, and
a third step of inverting the voltage by turning on the second and third switching devices during the next one period are performed, and
wherein the first to third steps are performed according to a pre-set firing angle, and the pre-set firing angle is increased when the frequency of the output voltage is reduced.

10. The apparatus of claim 5,
wherein as for the frequency switching pattern, when a frequency command to convert the frequency (f) of the commercial AC voltage into a voltage of f/2 is inputted by the user,
a first step of turning on the first and fourth switching devices during one period and
a second step of inverting the voltage by turning on the second and third switching devices during the next one period are performed, and
wherein the first and second steps are performed according to a pre-set firing angle and the pre-set firing angle is increased when the frequency of the output voltage is reduced.

11. The apparatus of claim 5,
wherein as for the frequency switching pattern, when a frequency command to convert the frequency (f) of the commercial AC voltage into a voltage of f/2 is inputted by the user,
a first step of turning on the first and fourth switching devices during a half period,
a second step of turning off the first and the fourth switching devices during the next half period,
a third step of inverting the voltage by turning on the second and third switching devices during the next half period, and
a fourth step of turning off the second and third switching devices during the next half period are performed,
wherein the first to fourth steps are performed according to a pre-set firing angle and the pre-set firing angle is increased when the frequency of the output voltage is reduced.

12. The apparatus of claim 5,
wherein as for the frequency switching pattern, when a frequency command to convert the frequency (f) of the commercial AC voltage into a voltage of f/3 is inputted by the user,
a first step of turning on the first and fourth'switching devices during a half period,
a second step of inverting the voltage by turning on the second and third switching devices during the next half period,
a third step of turning on the first and the fourth switching devices during the next half period,
a fourth step of inverting the voltage by turning on the second and third switching devices during the next half period, and
a fifth step of turning on the first and fourth switching devices during the next half period are performed,
wherein the first to fifth steps are performed according to a pre-set firing angle, and the pre-set firing angle is increased when the frequency of the output voltage is reduced.

13. The apparatus of claim 5,
wherein, as for the frequency switching pattern, when a frequency command to convert the frequency (f) of the commercial AC voltage into a voltage of f/3 is inputted by the user,
a first step of turning on the first and fourth switching devices during a half period,
a second step of inverting the voltage by turning on the second and third switching devices during the next half period,
a third step of turning off the second and third switching devices during the next half period,
a fourth step of turning on the first and the fourth switching devices during the next half (½) period,
a fifth step of inverting the-voltage by turning on the second and third switching devices during the next half period, and
a sixth step of turning off the second and third switching devices during the next half period are performed,
wherein the first to sixth steps are performed according to a pre-set firing angle, and the pre-set firing angle is increased when the frequency of the output voltage is reduced.

14. An apparatus for controlling a speed of a fan motor of an air-conditioner which comprises an HIM (Hybrid Induction Motor) having a stator, an induction rotor and a permanent magnet rotor installed between the stator and the induction rotor, comprising:
a frequency and voltage phase converter that simultaneously varies a voltage phase and frequency of a commercial AC power according to a control signal and applies a voltage varied according to the varied frequency and voltage phase to an HIM of the air-conditioner;
a zero voltage detector that receives the commercial AC power and detects a zero voltage of a voltage wave of the commercial AC power; and
a microcomputer electrically connected with the zero voltage detector and the frequency and voltage phase converter, generating the control signal providing a predetermined frequency switching pattern according to a frequency command based on a point when the zero voltage is generated, and outputting the control signal to the frequency and voltage phase converter,
wherein the frequency and voltage phase converter comprises:
a first triac;
a second triac connected in series to the first triac;
a third triac connected in parallel to the first triac; and
a fourth triac connected in series to the third triac and connected in parallel to the second triac, wherein the HIM is electrically connected with a first junction between the first and second triacs and electrically connected with a second junction between the third and fourth triacs.

15. The apparatus of claim 14, wherein the microcomputer comprises a memory that stores frequency switching patterns that have been predetermined according to the frequency command.

16. The apparatus of claim 14, wherein when the frequency of the output voltage is increased, the microcomputer reduces the firing angle of the output voltage waveform, and when the frequency of the output voltage waveform is reduced, the microcomputer increases the firing angle of the output voltage waveform.
